(19) United States
(12) Patent Application Publication
(10) Pub. No.: US 2026/0087668 A1
(43) Pub. Date: Mar. 26, 2026

(54) METHOD AND DEVICE FOR DETERMINING THE ABSOLUTE POSE OF A CAMERA LOCATED ON BOARD AN AIRCRAFT OR SPACECRAFT

(71) Applicants: AIRBUS DEFENCE AND SPACE SAS, Toulouse Cedex 4 (FR); AIRBUS HELICOPTERS, MARIGNANE CÉDEX (FR)

(72) Inventor: Roland BROCHARD, TOULOUSE CEDEX 4 (FR)

(21) Appl. No.: 19/397,551

(22) Filed: Nov. 21, 2025

Related U.S. Application Data
(63) Continuation of application No. PCT/FR2024/050665, filed on May 24, 2024.

(30) Foreign Application Priority Data
May 24, 2023 (FR) 2305008

(51) Int. Cl. G06T 7/73; B64D 47/08; B64G 1/22; G01C 21/00; G06T 7/246; G06T 7/33

(52) U.S. Cl. CPC G06T 7/75; B64D 47/08; B64G 1/22; G01C 21/005; G06T 7/248; G06T 7/337; G06T 7/344; G06T 7/74; G06T 2207/10016; G06T 2207/10032; G06T 2207/30244

(57) ABSTRACT

A method (20) to determine an absolute pose of a camera (11) located on a craft (10) that is able to move relative to a scene, the method includes: obtaining (S20) a sequence of images of a scene captured by the camera, from the sequence of images generating a local 3D model in a coordinate system of the camera, the local 3D model representing a portion of the scene at a target image among the sequence of images, determining (S22) the absolute pose of the camera at the target image by realigning the position and attitude of the local 3D model with a predetermined reference 3D model corresponding to the scene represented in three dimensions in the reference coordinate system.

### RELATED APPLICATION

This application is a continuation of International Patent Application PCT/FR2024/050665, filed May 24, 2024, which claims priority to French Patent Application FR2305008, filed May 24, 2023, both of which are incorporated by reference.

### TECHNICAL FIELD

This invention lies within the general field of vision-based navigation (or VBN, as known in the literature) and relates more particularly to a method for determining an absolute pose, in a reference coordinate system, of a camera located on board an aircraft or spacecraft.

### BACKGROUND

In vision-based navigation systems, it is known to capture an image of a scene using a camera located on board a craft that is moving relative to the scene, and to compare this image to a reference image of the scene. This comparison aims to align the image captured by the camera with the reference image, i.e. to find and reposition the captured image in the reference image. Since the reference image is georeferenced, it is then possible to determine the position of the camera, and therefore that of the craft carrying it, relative to the scene.

However, many factors can affect accuracy in determining the position of the craft.

For example, while the reference image is generally an image captured under good viewing conditions, for example with no clouds and/or with a scene which on the whole is illuminated by the sun (particularly in the case of a reference image captured in visible wavelengths), this is not necessarily the case for the image captured by the camera on board the craft for which the position is to be determined. If the image is captured by the camera on board an aircraft or spacecraft while the scene is partly obscured by clouds and/or is receiving little sunlight, then the comparison with the reference image may prove complicated, which could lead to significant errors in determining the position of the craft relative to the scene.

Furthermore, the scene itself may be subject to seasonal variations. Thus, if the reference image represents the scene in summer and if the craft flies over the same scene in winter, comparing the reference image with the image captured by the camera on board this craft could prove complicated.

### SUMMARY

The present invention aims to resolve some or all of the disadvantages of the prior art, in particular those set forth above, by proposing a vision-based navigation solution which is robust against variations in the scene's observation conditions and against seasonal variations.

For this purpose, and according to a first aspect, a real-time method (20) is proposed for determining an absolute pose of a camera (11) in a reference coordinate system, said camera (11) being monocular and passive and being located on board an aircraft or spacecraft (10) that is able to move relative to a scene known and mapped in the form of a reference three-dimensional (3D) model, said method comprising:
obtaining (S20) a sequence of at least two successive images captured by the camera (11) at respective successive times, each image comprising a plurality of pixels, each pixel of an image partially representing the scene viewed by the camera at the time of capture of said image,
determining (S21), from the sequence of images, a local 3D model in a coordinate system that is centered and oriented relative to the camera (11), said local 3D model representing a portion of the scene in three dimensions corresponding to the capture of an image, referred to as target image, the determination (S21) of the local 3D model comprising a dense matching (S211) of all pixels of the target image with pixels of other images among said sequence,
providing (S220) an approximate absolute pose of the camera,
determining the absolute pose of the camera (11) at the time of capture of the target image, by realigning the position and attitude of the local 3D model with the reference 3D model, the position and attitude realignment being carried out in a search domain, based on the approximate absolute pose of the camera.

The proposed method therefore aims to determine the absolute pose of the camera in the reference coordinate system of a 3D map. “Absolute pose” is understood to mean the pose (position and attitude) of the camera in this reference coordinate system. Advantageously, the invention allows the method for determining the absolute pose to be used for vision-based navigation, particularly in real time. The absolute pose is different from the “relative pose” of the camera, the latter corresponding to the camera's pose in an arbitrary coordinate system, for example a coordinate system of the camera at the time of capture of a previous image in the sequence (in which case the relative pose corresponds to the variation in the camera pose between two times at which images were captured).

Several images captured by the camera are used to determine a local 3D model of the scene. It should be noted that a passive camera is considered here (i.e. one that simply makes passive measurements of electromagnetic radiation coming from the scene, unlike, for example, lidars or radars, which make active measurements by emitting electromagnetic radiation towards the scene and measuring the electromagnetic radiation reflected by the scene). Furthermore, since the camera is monocular, a single camera is therefore used to capture the sequence of images, which are therefore captured at different times by the same camera (monocular vision system) which in principle has moved between two capture times and therefore in principle is observing the scene from different viewpoints.

Furthermore, it should be noted that the term “3D model” here means a representation of the 3D geometry of the scene, and any type of representation of the 3D geometry can be considered in the present disclosure. Such a 3D model may therefore be, for example, in the form of a simple Digital Elevation Model, DEM (sometimes referred to as a “pseudo 3D” or “2.5D” model), or in a more complex form allowing the outer envelope of the volume formed by the scene to be spatially represented (for example, a mesh composed of vertices, edges, and polygonal surfaces).

Given that the reference 3D model is established in the reference coordinate system, the realignment (in position and attitude) of the local 3D model with the reference 3D model makes it possible to determine the absolute pose of the camera in the reference coordinate system, i.e. to determine both the position and attitude of said camera in said reference coordinate system.

Furthermore, the focus is primarily on the 3D geometry of the scene, which is independent of the scene's observation conditions and which in principle varies little with seasonal variations. Similarly, the 3D geometry of the scene does not depend on the type of physical characteristics measured in the scene. For example, a reference 3D model established from measurements (active or passive) carried out in visible wavelengths may be used to determine the absolute pose of a passive camera measuring electromagnetic radiation in infrared wavelengths.

This disclosure therefore proposes a vision-based navigation solution, and in particular therefore usable in real time, which is advantageously applicable regardless of the type of camera used for navigation. Indeed, since the images captured by this camera are used to determine a local 3D model that represents the 3D geometry of the scene (and not the electromagnetic radiation from the scene in a particular wavelength band), the same reference 3D model can be used to determine the absolute pose of any type of camera used for navigation.

In some particular modes of implementation, the method for determining the absolute pose may also optionally comprise one or more of the following features, individually or in any technically possible combination.

In some particular modes of implementation, the determination of the local 3D model comprises determining at least one relative pose of the camera for several successive images in the sequence.

In some particular modes of implementation, the determination of said relative pose of the camera for said several successive images in the sequence comprises visual odometry, followed by updating said relative pose by beam adjustment.

In some particular modes of implementation, the determination of the local 3D model comprises:
determining relative poses of the camera for said several successive images in the sequence, followed by
dense matching of all pixels of the target image with pixels of said several successive images in the sequence,
for each pixel of the target image actually matched: determining a 3D position of the pixel of the target image, in the camera's coordinate system, based on the relative poses, the two-dimensional (2D) position of said pixel in the target image, and the 2D positions of each matched pixel,
wherein the local 3D model is formed based on the 3D positions of the pixels actually matched in the target image.

In some particular modes of implementation, the dense matching of the pixels of the target image with pixels of the other successive images in the sequence comprises, for each other image among the other successive images in the sequence:
determining, based on the respective relative poses, a realignment transformation between the target image and said other image,
realigning said other image by means of the realignment transformation,
determining the residual motion from the target image to the realigned other image.

In some particular modes of implementation, the realignment transformation is a homography.

In some particular modes of implementation, the determination of the residual motion of the target image and of the realigned other image makes use of a dense optical flow algorithm.

In some particular modes of implementation, the determination of the absolute pose of the camera at the time of capture of the target image comprises:
projecting the local 3D model into the reference coordinate system, based on the approximate absolute pose,
matching the projected local 3D model with the reference 3D model, in the reference coordinate system.

In some particular modes of implementation, the approximate absolute pose is determined based on an absolute pose determined for the camera during the capture of a previous target image or based on a navigation instrument carried on board the aircraft or spacecraft.

In some particular modes of implementation, the local 3D model and the reference 3D model are filtered using a high-pass filter before determining the absolute pose of the camera.

In some particular modes of implementation, the images in the sequence of images that are obtained correspond to images, referred to as key images, selected from a sliding sequence of images, referred to as initial images, captured successively by the camera.

In some particular modes of implementation, an initial image is selected as a key image when a predetermined criterion of movement of the aircraft or spacecraft since the capture of the previous key image is satisfied.

In some particular modes of implementation, the camera is sensitive in visible and/or infrared wavelengths.

According to a second aspect, a real-time method for vision-based navigation is proposed using a monocular and passive camera connected to a platform of an aircraft or spacecraft that is able to move relative to a scene known and mapped in the form of a reference 3D model, which comprises:
determining an absolute pose of the camera in the reference coordinate system, by the method according to the first aspect,
determining the position and attitude of the aircraft or spacecraft, in the reference 3D model, based on the absolute pose modified according to a position of the camera relative to the platform of the aircraft or spacecraft.

According to a third aspect, a computer program product is provided comprising instructions which, when executed by at least one processor, configure said at least one processor to implement a method according to any one of the aspects and/or modes of implementation of this disclosure.

According to a fourth aspect, a computing device is provided comprising at least one processor and at least one memory, said at least one processor being configured to implement a method according to any one of the aspects and/or modes of implementation of this disclosure.

According to a fifth aspect, an aircraft or spacecraft is provided, comprising a platform carrying a camera and a computing device according to any one of the embodiments of this disclosure. It should be noted that spacecraft is understood to mean any craft operating outside the Earth's atmosphere, including a craft operating on the ground on a celestial body other than the Earth (satellite, space shuttle, rover, etc.) or flying over such a celestial body.

### SUMMARY OF DRAWINGS

The invention will be better understood upon reading the following description, given by way of non-limiting example, and made with reference to the figures which show:

FIG. 1 is a schematic representation of an example of a craft carrying a camera for capturing images of a scene relative to which the craft is likely to move,

FIG. 2 is a diagram illustrating the main steps of an exemplary implementation of a method for determining an absolute pose of the camera located on board the craft,

FIG. 3 is a diagram illustrating the main steps of an exemplary implementation of a step for determining a local 3D model of the scene in the method for determining an absolute pose,

FIG. 4 is a diagram illustrating the main steps of an exemplary implementation of a step for determining relative poses of the camera for different images captured by the camera,

FIG. 5 is a diagram illustrating the main steps of an exemplary implementation of a step of matching pixels in the step for determining the local 3D model of the scene,

FIG. 6 is a schematic representation of pixels from two images representing the same elements of a scene,

FIG. 7 is a diagram illustrating the main steps of an exemplary implementation of determining the absolute pose,

FIG. 8 is a schematic representation of an exemplary local 3D model before and after high-pass filtering.

In these figures, identical references in different figures designate identical or similar elements. For clarity, the elements shown are not to scale unless otherwise indicated.

Furthermore, the order of the steps shown in these figures is given solely as a non-limiting example of this disclosure, which may be applied while performing the same steps in a different order.

### DETAILED DESCRIPTION

As indicated above, the invention relates to a method 20 for determining an absolute pose of a camera 11 in a reference coordinate system, the camera 11 being mounted on an aircraft or spacecraft 10 that is able to move relative to a scene. It should be noted that a “spacecraft” refers to any craft operating outside the Earth's atmosphere, including a craft operating on the ground on a celestial body other than the Earth (satellite, space shuttle, rover, etc.). An aircraft may be any craft that flies in the Earth's atmosphere (airplane, helicopter, drone, etc.).

“Absolute pose” refers to the pose of the camera 11 in the reference coordinate system considered, i.e. the position (3D) and attitude (orientation) of said camera 11 in this reference coordinate system.

The camera may be calibrated, which offers better guarantees of accuracy and reproducibility.

To measure the camera's position relative to the platform of the aircraft or spacecraft (10), a coordinate system linked to one or more other sensors is used for example, in particular the inertial measurement unit (IMU) or the GPS. Inter-sensor calibration is performed, for example, by taking simultaneous measurements from all sensors and estimating the geometric transformations that allow optimally superimposing these different measurements. Generally, for example, maneuvers are performed that maximize observability across all sensors.

There may be a single-unit assembly, detachable from the platform and integrating several sensors that are fixed relative to each other. The single-unit assembly can then be manually oriented in multiple directions while observing distant objects such as buildings, the horizon, or the ground as seen from the top of a building.

The reference coordinate system may be of any type suitable for identifying the position and attitude of the camera 11 in a three-dimensional space and is typically defined by an origin and three non-coplanar axes, for example orthogonal. In some cases, the reference coordinate system concerned depends on the scene being flown over. For example, if the scene being flown over is a scene on the Earth's surface, the reference coordinate system may be a geocentric coordinate system or a coordinate system having its origin at a particular point on the Earth's surface. If the spacecraft 10 is flying over another type of celestial body, for example another planet or an asteroid, the reference coordinate system is, for example, centered on that celestial body or on a particular point on the surface of that celestial body.

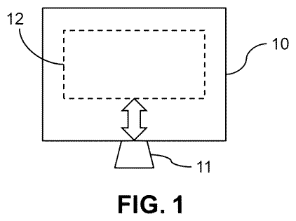

FIG. 1 schematically represents an exemplary embodiment of a spacecraft or aircraft 10. As illustrated in FIG. 1, the craft 10 comprises the camera 11 and a computing device 12.

The camera 11 may be of any type suitable for capturing two-dimensional (2D) images of the scene in a passive manner (i.e. simply measuring electromagnetic radiation from the scene, without first emitting electromagnetic radiation towards it). The camera 11 is configured to measure electromagnetic radiation in one or more bands of determined wavelengths. For example, the camera 11 is configured to measure electromagnetic radiation in visible wavelengths, i.e. wavelengths between 380 nanometers (nm) and 780 nm. Additionally or alternatively, the camera 11 may be configured to measure electromagnetic radiation in infrared wavelengths, i.e. wavelengths between 780 nm and 5 millimeters (mm). For example, the camera 11 is sensitive in the near infrared (NIR, i.e. in wavelengths between 780 nm and 3 micrometers (μm)) and/or in the mid infrared (MIR, i.e. in wavelengths between 3 μm and 50 μm).

The images captured by the camera 11 are for example in the form of a matrix of pixels providing physical information about the area of the scene located within the field of view of the camera 11. The images are, for example, matrices of Nₓ×N_{y} pixels, Nₓ and N_{y} each being for example on the order of a few hundred to a few tens of thousands of pixels. The images are typically captured by the camera 11 in a recurring manner, for example periodically at a frequency which is for example on the order of a few Hertz (Hz) to a few hundred Hz.

It should be noted that a monocular vision system (as opposed to stereoscopic in particular), comprising a single camera 11, is sufficient for implementing the method 20 for determining an absolute pose. The camera 11 is utilized to capture a sequence of images of the scene, which are therefore captured at different times by the same camera (monocular vision system) which in principle has moved between two capture times and therefore observes the scene from points of view which in principle are different.

It should be noted that the craft 10 may comprise vision sensors other than the camera 11, but the invention makes it possible to determine the absolute pose of the camera in the reference coordinate system, by using images captured by the one camera 11.

The computing device 12 is configured to implement all or part of the steps of the method 20 for determining an absolute pose of the camera 11. In the non-limiting example illustrated by FIG. 1, the computing device 12 is carried on board the spacecraft or aircraft 10. However, in other examples, it is possible to have a computing device 12 which is not carried on board the craft 10 and which is remote from said craft 10. Where appropriate, the images captured by the camera 11 may be sent to the computing device 12, then information relating to the absolute pose of the camera may be sent back, by any type of suitable communication means.

The computing device 12 comprises, for example, one or more processors (CPU, DSP, GPU, FPGA, ASIC, etc.). In the case of several processors, these may be integrated into a same device and/or integrated into separate hardware devices. The computing device 12 also comprises one or more memories (magnetic hard disk, electronic memory, optical disk, etc.) in which, for example, a computer program product is stored in the form of a set of program code instructions to be executed by the processor(s) in order to implement all or part of the steps of the method 20 for determining an absolute pose of the camera 11.

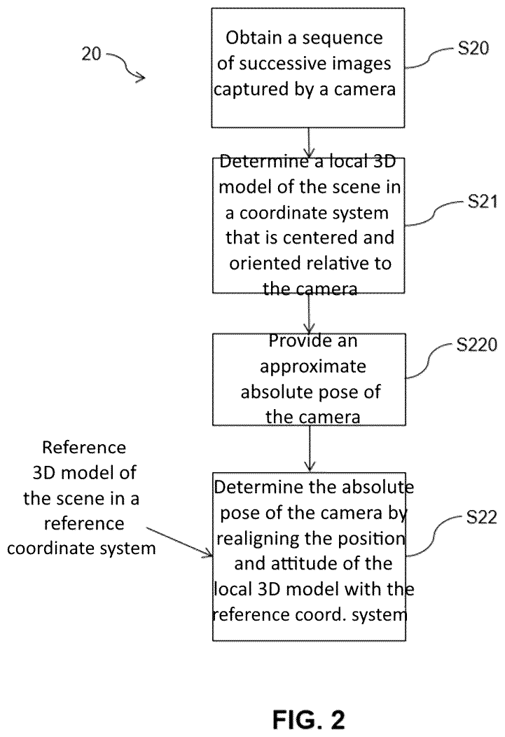

FIG. 2 schematically represents the main steps of a method 20 for determining an absolute pose of the camera 11 in the reference coordinate system. It should be noted that, since the position and orientation of the camera 11 relative to the craft 10 carrying it are known or can be determined at any time, the absolute pose of the camera 11 in the reference coordinate system may, for example, be used to determine the absolute pose of the spacecraft or aircraft 10 in the reference coordinate system, for example for vision-based navigation purposes, possibly in combination with navigation measurements provided by navigation sensors (GPS receiver, accelerometer, odometer, gyroscope, etc.) which may be on board the craft 10.

As illustrated in FIG. 2, the method 20 for determining an absolute pose comprises a step S20 of obtaining a sequence of images of said scene. The sequence of images obtained during step S20 are images captured by the camera 11 at respective successive times and are therefore likely to represent the scene from different viewpoints. For example, the sequence of images obtained during step S20 comprises a predetermined number N_{C} of images, where N_{C}≥2, N_{C}≥3, N_{C}≥5 or 6≤N_{C}≤10. In effect, it is important to track the pixels in order to measure significant differences, which correspond to movement, so as to improve the accuracy of the 3D perception. However, the greater the difference from one image to another, the more difficult it is to track the pixels precisely. This is why it may be advantageous to use intermediate images in order to track the pixels through the intermediate images.

According to a first example, it is possible to use all the images captured successively (for example periodically) by the camera 11, such that the sequence of images obtained corresponds to N_{C} images captured successively by the camera 11.

According to another example, to determine the absolute pose of the camera 11, it is possible not to use all the images captured by the camera. If “initial images” refers to all images captured successively by the camera, then the N_{C} images obtained during step S20, hereinafter referred to as “key images”, are the images selected among the initial images captured successively by the camera 11.

In general, such a selection of key images, which amounts to discarding certain initial images, aims to try to increase the probability of obtaining a sequence of key images representing the scene from viewpoints which are actually different. Indeed, since the time difference between the capture times of two successive initial images may be small, the variation in viewpoint may sometimes be negligible between two successive initial images, and this may also depend on the movement of the craft 10 relative to the scene. For example, it is possible to select one initial image out of every n_{C} initial images, as a key image. In this case, if the initial images are captured at a period T_{I}, then the key images are captured at a period n_{C}·T_{I}, n_{C} being greater than or equal to 10 for example, or greater than or equal to 100 for example.

According to another example, the selection may make use of a predetermined criterion of movement of the craft 10 since the capture of the previous key image, and an initial image is selected as a key image when this movement criterion is satisfied. The evaluation of the movement of the craft 10, even if approximate, may make use of any method known to those skilled in the art. For example, it is possible to use an estimate of the movement of the craft 10 provided by a navigation filter, or measurements provided by an inertial measurement unit of the craft 10, to evaluate whether the movement criterion is satisfied (i.e. whether the estimated movement is greater than a minimum required movement). In modes of implementation, the movement evaluation is performed using the content of the initial images. For example, using a given key image (the first key image may arbitrarily be chosen), it is possible to compare the content of an initial image with the content of this key image. If the content of the initial image and of the key image concerned are substantially different, this means that the craft 10 has moved and the initial image concerned can be selected as another key image. For example, it is possible to identify characteristic patterns (a characteristic pattern corresponds to a set of pixels representing a characteristic element of the scene) in the key image considered, and to follow these characteristic patterns in the subsequent initial images (“tracking” in the literature). Where appropriate, the movement criterion is for example considered to be satisfied if a predetermined percentage of reference patterns could not be tracked in the initial image concerned.

The remainder of the description considers a sequence of successive images ready to be processed, which may, for example, consist of key images.

One of these images, among the sequence of images obtained during step S20, is designated the “target image,” and corresponds to the image relative to which the absolute pose of the camera 11 is to be determined. In other words, the absolute pose to be determined corresponds to the absolute pose at the time the target image was captured. The target image may be any of the images in the sequence of images. The target image may correspond to the image captured last in the sequence, i.e. the one having the newest capture time.

In order to determine successive absolute poses of the camera 11, it is possible, for example, to consider a sliding sequence of images. For example, the sequence of images (i.e. the N_{C} images forming the sequence of images) that was previously used to determine the absolute pose of the camera 11 may be updated during step S20 by deleting the oldest image from this sequence and adding to this sequence a new image just selected among the latest initial images captured by the camera 11.

As illustrated in FIG. 2, the method 20 for determining an absolute pose comprises a step S21 of determining a local 3D model, based on the sequence of images. The local 3D model represents the 3D geometry of a portion of the scene as viewed by the camera 11 at the time the target image was captured. The local 3D model represents the 3D geometry of this portion of the scene in a coordinate system of the camera 11, meaning in a coordinate system for which the origin and orientation are defined in relation to the camera 11 (and which is different from the reference coordinate system concerned).

Thus, the sequence of images which partially represent the scene, as viewed from different viewpoints, is used to reconstruct the 3D geometry of this portion of said scene. Assuming that most of the constituent elements of the scene are unmoving, the various images, captured at respective successive times and representing the scene as viewed from respective different viewpoints, may in fact be used to reconstruct the 3D geometry of a portion of the scene, visible at the time the target image was captured, by making use of multi-view 3D reconstruction methods (based on the principle of “Structure From Motion”, SFM, in the literature). In general, any multi-view 3D reconstruction method known to those skilled in the art may be implemented during step S21 of determining the local 3D model, and the choice of a particular method only constitutes a non-limiting variant implementation of the method 20 for determining the absolute pose.

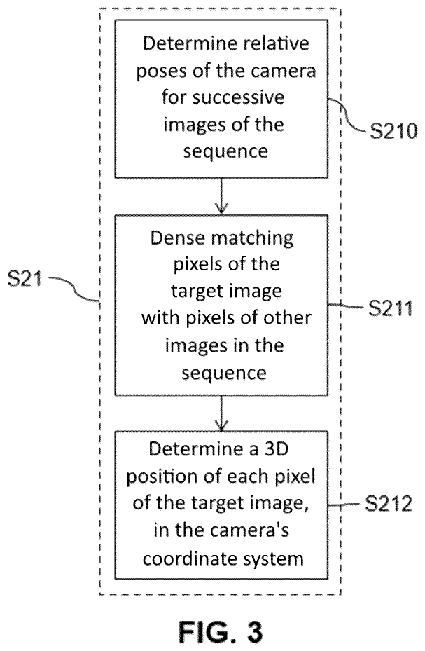

FIG. 3 schematically represents the main steps of an exemplary implementation of the step S21 of determining the local 3D model of the scene in the camera's coordinate system.

As illustrated by FIG. 3, in this example the step S21 of determining the local 3D model comprises a step S210 of determining one or more relative poses of the camera 11 for some or all of the images in the sequence of images.

As indicated above, the relative pose of an image corresponds to the pose of the camera 11 in an arbitrary coordinate system, for which the position and/or orientation in the reference coordinate system are not initially known (or at least not with sufficient precision). For example, the arbitrary coordinate system may be the coordinate system of the camera 11 at the time of capture of one of the images in the sequence. The scale is obtained for example by realigning the path obtained based on the relative poses of the camera, realigning to the assumed path obtained using its approximate absolute poses provided for example by an inertial measurement unit. The arbitrary coordinate system may also vary from one image to another, for example it could be the coordinate system of the camera 11 at the time the previous image in the sequence of images was captured.

For example, step S210 of determining one or more relative poses may make use of a method of visual odometry, which allows, for example, determining the variation in pose from one image to another by analyzing the content of the images.

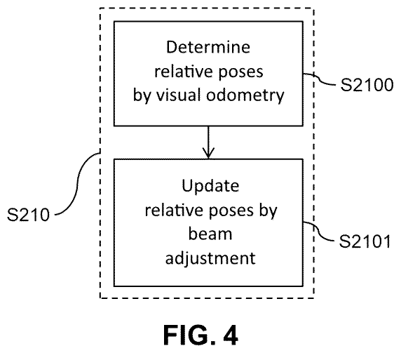

FIG. 4 schematically represents the main steps of an exemplary implementation of the step S210 of determining the relative poses of the camera 11. As illustrated by FIG. 4, step S210 comprises:
a step S2100 of determining the relative poses of the camera 11 for some or all of the images in the sequence of images, by visual odometry,
a step S2101 of updating the determined relative poses, by beam adjustment.

Thus, in this example, the relative poses are determined in at least two stages.

A first estimate of the relative poses is first obtained during step S2100 by visual odometry, for example by tracking pixels (or pixel patterns) from one image to another, these pixels being assumed to represent the same portions of the scene. Several pixels of a same image are respectively matched with several pixels of one or more other images in the sequence. It should be noted that, in certain exemplary implementations, this step S2100 of determining the relative poses of the camera 11 may be implemented in order to determine the relative pose of the camera 11 for each initial image captured by the camera 11.

However, in certain cases, the accuracy of the relative poses determined by visual odometry may be limited, due to a possible accumulation of errors (the error made in the estimated relative pose for an image can propagate from one image to another).

After the visual odometry, we have for example relative poses estimated for each of the images in the sequence. The coordinates of a pixel in the image characterize a line of sight, i.e. a half-line in 3D space, starting from the optical center of the camera and passing through the center of the pixel. Knowing the pose of the camera, this half-line can be repositioned into the coordinate system in which the pose is expressed.

The step S2101 of updating by beam adjustment aims to improve the accuracy of the relative poses determined during the previous step S2100 using visual odometry.

The beam adjustment is based on the principle that, for two images captured by the camera 11 at different capture times, the lines of sight coming from the camera 11 and associated with pixels representing the same portion of the scene in the two images, must intersect at said same portion. Pixels of different images representing a same portion of the scene are said to be “matched”.

During the step S2101 of updating by beam adjustment, the relative poses are updated to ensure that the lines of sight associated with pixels of different images, the pixels having been matched, substantially intersect at a same portion (point), and do so for several portions of the scene which are represented in several images. In practice, it is generally not possible to have lines of sight that strictly intersect, and “substantially intersect” is understood to mean that said lines of sight are at least close to intersecting.

For example, it is possible to use a Levenberg-Marquardt algorithm to update the relative poses of the first and last images in the sequence, using an epipolar error (in pixels) as a metric. This makes it possible to determine approximate 3D positions, in an arbitrary coordinate system, of the portions of the scene identified as visible in both the first and last images in the sequence (the approximate 3D positions corresponding to the coordinates at which the corresponding lines of sight substantially intersect). The relative poses of the other images in the sequence of images can then be updated based on these approximate 3D positions, using a Perspective-n-Point (PNP) problem-solving algorithm, for example the SolvePnP function in the OpenCV library.

After the beam adjustment, we have for example relative poses of the camera which have been determined for each of the images in the sequence.

As illustrated in FIG. 3, the determination of the local 3D model further comprises, in this example, a step S211 of matching pixels of the target image with pixels of other images in the sequence of images. As indicated above, pixels matched to each other correspond to pixels of different images which are considered to represent the same portion (or point) of the scene, which in principle is therefore viewed from different viewpoints. It should be noted that the matching performed in step S211 is advantageously a “dense” matching, i.e. all the pixels of the target image are matched with pixels of other images in the sequence of images. Obviously, it is not always possible, for a given pixel of the target image, to identify a pixel of another image that represents the same portion of the scene (because, since the craft 10 is able to move, this portion is not necessarily within the field of view of the camera 11 when the other image is captured). However, this search for corresponding pixels in the other images may be carried out for each pixel of the target image, in order to identify a large number of portions of the scene that are visible in several images.

In particular, if pixel matching is carried out during the step S210 of determining relative poses, this concerns a much smaller number of pixels than the number of pixels matched during the step S211 of dense matching. Such arrangements make it possible to improve the accuracy and resolution of the local 3D model, and, ultimately, to improve the accuracy of the determination of the absolute pose of the camera 11. The use of a reduced set of points to measure the poses allows a rapid estimation, compatible with the constraints of a real-time system, for example a vision-based navigation system. However, the geometric information which subsequently allows matching with the 3D map cannot be extracted from this reduced set of points. Therefore the geometric information which subsequently allows matching with the 3D map is obtained by means of the next step S211 of dense matching the target image with pixels of said several successive images in the sequence. It should be noted that all these processing operations are applied incrementally to an image stream: it is not necessary to have all the images in order to start the processing. Each new image allows obtaining additional measurements, but is not necessary for the preceding measurements.

The matching step S211 may make use of any dense matching method known to those skilled in the art, the choice of a particular method only constituting a non-limiting variant implementation for determining the local 3D model. For example, the matching step S211 may make use of a dense optical flow algorithm. After matching the pixels of the target image with pixels of other images in the sequence, we have pixels of the target image which in effect are each associated with one or several pixels of one or several other images in the sequence.

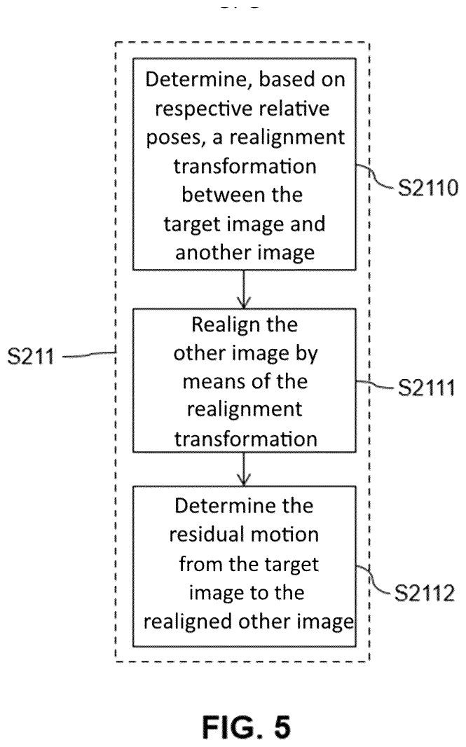

FIG. 5 schematically represents the main steps of an exemplary implementation of the step of matching pixels of the target image with pixels of other images in the sequence. In this example, the relative poses determined during the step of determining relative poses are used.

For example, to match the pixels of the target image with the pixels of another image in the sequence of images, it is possible to determine, during a step S2110, a realignment transformation between the target image and this other image, based on the relative poses for these two images. The realignment transformation aims to bring the target image and this other image into similar acquisition geometries, for example by bringing this other image into an acquisition geometry that is close to that of the target image (or vice versa). For example, the realignment transformation makes it possible to predict the pixel of the other image that theoretically represents the same portion of the scene. Indeed, the positions of the pixels representing the same portion of the scene may vary from one image to another, in particular due to the change in pose of the camera 11 relative to the scene.

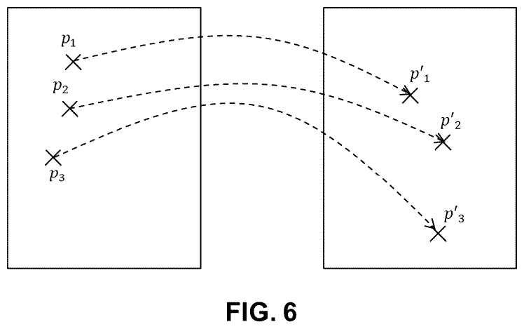

FIG. 6 schematically represents two successive images, and pixels representing the same portions of the scene in these images. More specifically, pixel p₁ and pixel p′₁ represent the same portion of the scene, pixel p₂ and pixel p′₂ represent the same portion of the scene, and pixel p₃ and pixel p′₃ represent the same portion of the scene. However, the position of pixel p₁ in the left image is different from the position of pixel p′, in the right image (and the same for pixels p₂ and p′₂, and for pixels p₃ and p′₃). The realignment transformation aims to try to predict, based on the position of a pixel in the target image, the position of the pixel representing the same portion of the scene in the other image (or vice versa).

In some cases, the realignment transformation may be determined by making simplifying assumptions, particularly regarding the geometry of the scene. For example, in some cases, the realignment transformation corresponds to a homography. In a manner that is known per se, a homography models motion by assuming that the portions of the scene represented by the pixels are located in the same plane, i.e. by assuming that the scene is generally a flat surface. Such a homography is simple to model and is also sufficient in many cases.

However, in other examples, nothing precludes modeling the approximate geometry of the scene in a different manner for the determination of the realignment transformation. It should be noted that this modeling of the approximate geometry of the scene is intended solely to establish the realignment transformation that is used to facilitate pixel matching, and is therefore distinct from the local 3D model.

Following this step S2110, a realignment transformation between the two images is determined.

The realignment transformation is then used, during a next step S2111, to align the target image and the other image with each other, i.e. to bring the target image and the other image as close as possible to the same acquisition geometry. The appearance of an element of the scene in an image varies according to the point of view of this image when captured. This realignment therefore makes it possible to obtain a target image which more closely resembles the other image. For example, the target image is brought as close as possible to the acquisition geometry of the other image, i.e. the target image is used to predict (by applying the realignment transformation to the target image) a predicted image representing the scene from the point of view of the other image, which therefore more closely resembles this other image than the target image.

During a subsequent step S2112 of dense matching, the images obtained after realignment are paired in order to identify all pixels that can be matched to each other. Such dense matching may be performed using any method known to those skilled in the art. For example, this matching may make use of processing that correlates pixel patterns of the target image and of the image obtained after realignment, or a dense optical flow algorithm. After the dense matching, the residual motion between the pre-compensated image and the target image is obtained.

Generally speaking, the prior use of the realignment transformation before matching, in order to align the images concerned beforehand, makes it possible to improve the robustness and accuracy of the matching. Different types of realignment transformation may be used, which in particular may model the geometry of the scene differently. However, the use of a homography has the advantage of being simple to determine and to apply, while still achieving good results in many cases for dense pixel matching. Simplifying the pixel-to-pixel matching problem in this manner allows the use of algorithms which are simpler (thus less expensive to validate, qualify, and certify), faster, and more capable of meeting the constraints of real-time execution that are essential for an on-board system.

As illustrated by FIG. 3, when determining the local 3D model, step S211 of matching pixels of the target image with pixels of the other images in the sequence is followed by a step S212 of determining a 3D position of each pixel of the target image, at the time of capture of the target image, in the coordinate system of the camera 11. The determination of the 3D position, relative to the camera 11 at the time of capture of the target image, of each portion of the scene represented by matched pixels in different images, takes into account the relative poses and the positions of the various matched pixels in the images. The determination of the 3D position for example triangulates the pixels mapped to each other, by determining the 3D position of the portion of the scene considered to be the intersection of the lines of sight respectively associated with the pixels mapped to each other (or at least the 3D position at which the lines of sight substantially intersect).

At the end of the step S212 of determining 3D positions, a plurality of 3D positions of different portions of the scene, relative to the camera 11 at the time of capture of the target image, have been determined. These 3D positions of the portions of the scene therefore describe the 3D geometry, in the coordinate system of the camera 11, of a portion of the scene as viewed by said camera 11 at the time of capture of the target image. These 3D positions of the portions of the scene thus form the local 3D model.

As indicated above, the matching performed during step S211 is a dense matching, so the local 3D model obtained represents the 3D geometry of this portion of the scene with a 2D resolution that is the order of the resolution of the target image. For example, the local 3D model may be in the form of a 2D image consisting of pixels associated with portions of the same dimensions (resolution) as the pixels of the target image. However, the value of a pixel of the 2D image of the local 3D model represents the third dimension, for example in the form of the distance between the camera 11 and the portion of the scene represented by this pixel, while the value of a pixel of the target image represents a physical quantity representative of the electromagnetic radiation coming from the portion of the scene represented by this pixel.

As illustrated by FIG. 2, the step of determining S21 the local 3D model is followed by a step S22 of determining the absolute pose of the camera 11 at the time of capture of the target image, by realigning elements of the local 3D model, in position and attitude, to the predetermined reference 3D model of said scene.

The reference 3D model represents the 3D geometry of the scene in the reference coordinate system. This is therefore initial information about the scene, which represents the 3D geometry of the scene, correctly oriented, positioned, and dimensioned in the reference coordinate system. For example, the reference 3D model corresponds to a Digital Terrain Model (DTM), or to a DEM that is correctly oriented, positioned, and dimensioned in the reference coordinate system (for example georeferenced in the case of a scene on the Earth's surface). In a manner that is known per se, a DTM represents the 3D geometry of the ground of the scene without taking into account the various elements located above the ground (buildings, vegetation, etc.), unlike a DEM which represents the 3D geometry of the scene while taking into account the elements located above the ground.

Such a reference 3D model may be previously established using any 3D mapping method known to the person skilled in the art, and the choice of a particular method only constitutes a non-limiting variant implementation of the method 20 for determining an absolute pose.

It should be noted that the reference 3D model may in particular be determined by applying the same steps as for determining the local 3D model, based on a sequence of images captured by a camera whose position and attitude in the reference coordinate system are precisely known during the capture of the sequence of images (for example determined using a GPS receiver, etc.). It should be noted that, in certain cases, the camera used to establish the reference 3D model of the scene may be the camera 11 of the craft 10. For example, in the case where the craft 10 is making a round trip that flies over the same scene, and if the craft 10 is equipped for example with a GPS receiver, it is possible during the outward journey of the craft 10 to determine the reference 3D model, and during the return journey of the craft 10 to use the method 20 for determining an absolute pose for the purposes of navigation of the craft 10, for example to compensate for a failure of the GPS receiver. In the absence of a GPS sensor, it remains possible to produce a non-metric map that allows retracing the path.

The reference 3D model depends on the scene, and the computing device 12 is therefore configured to retrieve the reference 3D model associated with the scene being flown over, for example from a database which may be carried on board the spacecraft or aircraft 10, or may be remote from said craft 10. For example, the database may store a single reference 3D model established specifically for a given mission of flying over the associated scene. In other examples, the database may store several reference 3D models respectively associated with different scenes which may be flown over. In such a case, the computing device 12 selects and retrieves the reference 3D model to be used, based on information which allows identifying the scene to be flown over by the craft 10 (for example based on approximate coordinates of the scene or of the craft 10, etc.). In the case described above, where the craft 10 is making a round trip and establishes the reference 3D model on the outward journey, during the return journey it is sufficient to retrieve from the database the reference 3D model that has just been established.

Realigning the position and attitude of the local 3D model with the reference 3D model is intended to align the local 3D model relative to the reference 3D model. This realignment is carried out on the position and attitude. It should be noted that the position realignment is carried out in three dimensions (3D position), meaning that the realignment aims to find not only the location (essentially a 2D position) within the reference 3D model where the 3D geometry described by the local 3D model is found, but also an orientation and a scale factor that describes the resizing necessary to locally match the local 3D model with the reference 3D model. The scale factor is deduced from the distance between the camera 11 and the scene and therefore allows finding the altitude component (third dimension) of the 3D position of the absolute pose to be determined. For example, the realignment is carried out by correlation processing, such as by tiling, between the local 3D model and the reference 3D model, or according to any realignment method known to the person skilled in the art, for example by a method of detecting and describing prominent elements, using an “Iterative Closest Point” (ICP) type of method.

Given that the reference 3D model is established in the reference coordinate system, the realignment of the local 3D model to the reference 3D model makes it possible to determine the absolute pose of the camera 11 in the reference coordinate system, at the time of capture of the target image, i.e. to determine both the position (3D) and the attitude of the camera 11 in the reference coordinate system.

As indicated above, the realignment in position and attitude of the local 3D model to the reference 3D model aims to locate the local 3D model within the reference model.

In some cases, such a realignment may perform a scan in a search domain that corresponds to ranges of possible realignment values for the position (2D position and scale factor) and attitude, in order to identify realignment values that allow optimizing a predetermined resemblance function, representative of the resemblance between the local 3D model (recalibrated according to the considered recalibration values) and the reference 3D model. For example, the resemblance function corresponds to a processing by correlating the local 3D model (realigned according to the considered realignment values) and the reference 3D model.

It should be noted that in some cases the scale factor may be provided by other means, at least approximately. For example, the scale factor may be determined from measurements provided by an inertial measurement unit of the craft 10 (for example predicted from these measurements by means of a navigation filter). If the scale factor thus determined is considered sufficiently accurate, then there is no need for further scaling in step S22, for example there is no need to sweep a range of possible values for the scale factor. Otherwise, the approximate scale factor may, for example, be used to reduce the search domain of the scale factor in step S22.

Generally, any initial information about the absolute pose may be used to reduce the search domain (and to reduce the probability of false detection). In certain cases, it is possible to obtain an approximate absolute pose of the camera 11 which can be used to reduce the search domain, and thus to speed up and improve the realignment of the local 3D model with the reference 3D model. For example, the approximate absolute pose for the current target image may be determined based on the absolute pose previously determined for the capture time of the previous target image and/or based on measurements provided by an inertial measurement unit of the craft 10. In such case, the step S22 of determining an absolute pose of the camera 11 aims to improve the precision of the determined absolute pose compared to the approximate absolute pose.

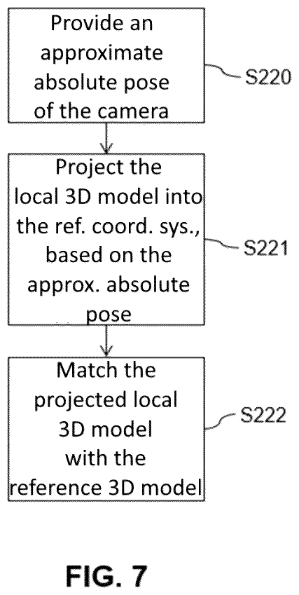

FIG. 7 schematically represents the main steps of an exemplary implementation of the step S22 of determining an absolute pose of the camera 11 in the reference coordinate system, which comprises:
a step S220 of obtaining an approximate absolute pose of the camera 11 at the time of capture of the target image,
a step S221 of projecting the local 3D model of a portion of the scene at the time of capture of the target image, into the reference coordinate system, based on the approximate absolute pose,
a step S222 of realigning the projected local 3D model with the reference 3D model, in the reference coordinate system.

The projection step S221 essentially corresponds to changing the coordinate system (with a change of scale), from the coordinate system of the camera 11 to the reference coordinate system. This change of the coordinate system is carried out based on the approximate absolute pose which approximately describes the position (3D) and attitude of the coordinate system of the camera 11 in the reference coordinate system. By starting, for example, with a local 3D model which corresponds to a 2D image describing the distances of the various portions of the scene relative to the camera 11, we obtain for example a local 3D model which corresponds to a local DEM (local in that it represents a portion of the scene represented by the reference 3D model) in the reference coordinate system. The realignment step S222 is carried out on a reduced search domain, limited to the neighborhood around the approximate absolute pose obtained during the previous step S220. As indicated above, if the scale factor of the approximate absolute pose is considered sufficiently precise, it is not necessary to further rescale during step S222.

In some particular modes of implementation, the local 3D model (possibly after projection into the reference coordinate system) and the reference 3D model are filtered using a high-pass filter before being realigned in position and attitude, for the determination of the absolute pose of the camera 11. Such arrangements make it possible to facilitate the realignment in position and attitude between the local 3D model and the reference 3D model. For example, in the case where the local 3D model and the reference 3D model correspond to DEMs, then applying high-pass filtering makes it possible to highlight the high-frequency variations in elevation which correspond, for example, to the presence of buildings in the scene. In general, buildings, or more generally the structures which locally introduce rapid variations in elevation within the scene, and their respective positions, are important in determining the absolute pose of the camera 11, and in particular are more relevant and more easily exploitable than absolute values for the elevation. Conversely, slow variations in elevation within the scene (e.g. the slope of the ground on which a building is built) carry little information. Slow variations in elevation within the scene generally contain most of the difference between the two maps due to initial alignment errors, because the algorithm first tries, for example, to realign the average slope by using a translation even if this average slope comes from an initial attitude error or from drift in the poses used for the 3D reconstruction. Slow variations in elevation within the scene may also introduce more noise during processing to correlate the local 3D model with the reference 3D model. For example, the resolution of rapid variations in elevation, which are to be preserved, is on the order of a pixel in the local 3D model (DEM) of the scene. The parameters of the high-pass filter are therefore advantageously selected to preserve such rapid variations in elevation. It is also not necessary to completely eliminate low frequencies, as this allows aligning hills or other large natural structures.

When applying the high-pass filter, it is necessary for example to consider what is retained, such as buildings, but also what is eliminated by this high-pass filter. In effect, the high-pass filter allows removing the 3D information that is the least properly reconstructed and which particularly disrupts the realignment.

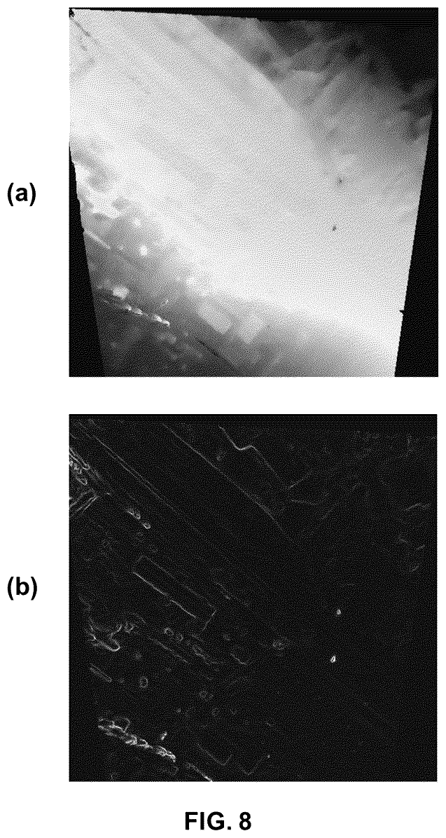

For example, FIG. 8 schematically represents an example of a local 3D model (projected into the reference coordinate system by using an approximate absolute pose of the camera 11) before high-pass filtering (part (a) of FIG. 8) and after high-pass filtering (part (b) of FIG. 8). In the example illustrated in FIG. 8, the local 3D model corresponds to a DEM. As illustrated in part (a) of FIG. 8, the elevation essentially varies with the slope of the scene, and rapid variations in the scene elevation are sometimes negligible compared to the absolute elevation. In part (b) of FIG. 8, rapid variations in elevation are highlighted using high-pass filtering and one can see that they provide more information for determining the absolute pose of the camera. One does indeed understand that rapid variations in elevation within a scene better characterize the scene (for example compared to another scene) than slow variations in elevation within this scene.

Another advantage of high-pass filtering is that it removes edge effects. Indeed, as shown in part (a) of FIG. 8, the local 3D model is only defined locally (the areas on the left, right, and top edges of part (a) are not defined), which introduces elevation discontinuities at the edges during realignment of the position and attitude with the reference 3D model. These discontinuities, which could lead to the presence of artifacts during correlation, are removed by the high-pass filtering, as illustrated in part (b) of FIG. 8.

The present method advantageously uses the dense 3D representation. Indeed, for visual navigation, recognizable elements are generally small when viewed from the sky (buildings, streets, trees, roads), and therefore our dense approach allows us to reconstruct the salient elements that are relevant for matching, namely the edges/walls of buildings, subtle elevation differences between the center and edge of roads, and trees.

More generally, it should be noted that the modes of implementation and the embodiments considered above have been described as non-limiting examples, and that other variants are therefore possible.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A real-time method for determining an absolute pose of a camera in a reference coordinate system, said camera being monocular and passive and being located on board an aircraft or spacecraft that is able to move relative to a scene known and mapped in the form of a reference three-dimensional (3D) model, wherein the method comprises:
obtaining a sequence of at least two successive images captured by the camera at respective successive times, each image comprising a plurality of pixels, each pixel of an image partially representing the scene viewed by the camera at the time of capture of said image,
determining, from the sequence of images, a local 3D model in a coordinate system that is centered and oriented relative to the camera, said local 3D model representing a portion of the scene in three dimensions corresponding to the capture of an image, referred to as target image, among the sequence of images, the determination of the local 3D model comprising a dense matching of all pixels of the target image with pixels of other images among said sequence,
providing an approximate absolute pose of the camera,
determining the absolute pose of the camera at the time of capture of the target image, by realigning the position and attitude of the local 3D model with the reference 3D model, the position and attitude realignment being carried out in a search domain, based on the approximate absolute pose of the camera.

2. The method according to claim 1, wherein the determination of the local 3D model comprises determining at least one relative pose of the camera for several successive images in the sequence.

3. The method according to claim 2, wherein the determination of said relative pose of the camera for said several successive images in the sequence comprises visual odometry, followed by updating said relative pose by beam adjustment.

4. The method according to claim 2, wherein the determination of the local 3D model comprises:
determining relative poses of the camera for said several successive images in the sequence, followed by dense matching of all pixels of the target image with pixels of said several successive images in the sequence,
for each of the pixels of the target image matched with the successive images, determining a 3D position of the pixel of the target image, in the coordinate system of the camera, based on the relative poses, the two-dimensional (2D) position of said pixel in the target image, and the 2D positions of each matched pixel,
wherein the local 3D model is formed based on the 3D positions of the pixels actually matched in the target image.

5. The method according to claim 4, wherein the dense matching of the pixels of the target image with pixels of the other successive images in the sequence comprises, for each other image among the other successive images in the sequence:
determining, based on the respective relative poses, a realignment transformation between the target image and said other image,
realigning said other image by means of the realignment transformation, and
determining the residual motion from the target image to the realigned other image.

6. The method according to claim 5, wherein the realignment transformation is a homography.

7. The method according to claim 5, wherein the determination of the residual motion of the target image and of the realigned other image makes use of a dense optical flow algorithm.

8. The method according to claim 1, wherein the determination of the absolute pose of the camera at the time of capture of the target image comprises:
projecting the local 3D model into the reference coordinate system, based on the approximate absolute pose,
matching the projected local 3D model with the reference 3D model, in the reference coordinate system.

9. The method according to claim 1, wherein the approximate absolute pose is determined based on an absolute pose determined for the camera during the capture of a previous target image or based on a navigation instrument on board the aircraft or spacecraft.

10. The method according to claim 1, wherein the local 3D model and the reference 3D model are filtered using a high-pass filter before determining the absolute pose of the camera.

11. The method according to claim 1, wherein the images in the sequence of images that are obtained correspond to images, referred to as key images, selected from a sliding sequence of images, referred to as initial images, captured successively by the camera.

12. The method according to claim 11, wherein an initial image is selected as a key image when a predetermined criterion of movement of the aircraft or spacecraft since the capture of the previous key image is satisfied.

13. A real-time method for vision-based navigation using a monocular and passive camera connected to a platform of an aircraft or spacecraft that is able to move relative to a scene known and mapped in the form of a reference 3D model, which comprises:
determining an absolute pose of the camera in the reference coordinate system, according to the method of claim 1, then
determining the position and attitude of the aircraft or spacecraft, in the reference 3D model, based on the absolute pose modified according to a position of the camera relative to the platform of the aircraft or spacecraft.

14. A computer program product comprising instructions which, when executed by at least one processor, configure said at least one processor to implement the method according to claim 1.

15. A computing device comprising at least one processor and at least one memory, said at least one processor being configured to implement the method according to claim 1.

16. An aircraft or spacecraft comprising a platform carrying a camera and a computing device according to claim 15.
